(19) United States
(12) Patent Application Publication
(10) Pub. No.: US 2020/0273107 A1
(43) Pub. Date: Aug. 27, 2020

(54) ASSET ALLOCATION FOR ASSURED MINIMUM OUTCOME

(71) Applicant: A&P Capital, LLC., Sunnyvale, CA (US)

(72) Inventors: Miguel PALACIOS LLERAS, Sunnyvale, CA (US); Hayne LELAND, Sunnyvale, CA (US); John O'BRIEN, Sunnyvale, CA (US)

(73) Assignee: A&P Capital, LLC., Sunnyvale, CA (US)

(21) Appl. No.: 16/175,273

(22) Filed: Oct. 30, 2018

Related U.S. Application Data
(60) Provisional application No. 62/578,862, filed on Oct. 30, 2017.

(51) Int. Cl. G06Q 40/06

(52) U.S. Cl. CPC G06Q 40/06

(57) ABSTRACT

Systems, methods, and computer-readable media are disclosed herein that provide an asset management tool and a centralized platform that analyzes various investment vehicles and improves asset allocation between the different available investment vehicles so as to ensure two outcomes for investors. The first outcome is an assured minimum monthly/annual payment (income) to each investor over a defined period of time. The second outcome is maximum exposure of each investor's investment to plus portion conditioned on meeting the first outcome.

### RELATED APPLICATIONS

This application claims priority to U.S. Provisional Application No. 62/578,862 filed on Oct. 30, 2017, the entire content of which is incorporated herein by reference.

### BACKGROUND

One of the main objectives of any investor is to be able to, over the years, invest his or her assets in such a way as to be able to retire comfortably and with peace of mind. Many financial institutions advertise and promise such outcome and peace of mind to investors but often omit from their pitch to investors that the promises made are based on certain assumptions and inherent risks that exist in financial markets. These inherent risks can sometimes wipe out an entire investment portfolio of an investor and reduce his or her decades-long investment substantially, as witnessed and experienced by many people around the globe during the 2008 financial crisis. See, for example, “The Recession Hurt Americans' Retirement Accounts More than Anybody Knew” (The Atlantic, 2015, https://www.theatlantic.com/business/archive/2015/10/the-recession-hurt-americans-retirement-accounts-more-than-everyone-thought/410791/).

Even when investors avoid such financial crises and inherent risks, they often arrive at retirement with a portfolio having a certain value. The critical question then is how to manage and withdraw/allocate assets of the portfolio over the retirement years to ensure sustainable income therefrom.

Typical management strategies include a planned withdrawal scheme based on which a certain portion or percentage of the portfolio is periodically withdrawn by an investor while the remaining funds in the portfolio are further invested for future withdrawals. As is readily ascertainable, market volatility presents a significant risk to the remaining funds in such portfolio that can undermine the planned sustainable future withdrawals from the portfolio over the years.

Another typical strategy consists of buying annuities. When buying an annuity, typically from an insurance company, an investor pays an upfront lump sum to the insurance company in exchange for a guaranteed income during the retirement years. Annuities have significant drawbacks including (1) high fees, (2) the lump sum not being available for withdrawal by the investor in case of emergency (or high penalties in case of early withdrawals) and (3) the riskiness of the payment being tied to an underwriting insurance company's credit rating. Should there ever be a default on behalf of the insurance company the “guaranteed” retirement income is no longer guaranteed.

Another example strategy consists of investing in Target Date Funds (TDFs). The drawback of TDFs, other than the inherent market volatility, includes gradual reduction in high risk/high return investments as the investor nears retirement age. For example, a principal drawback of TDFs is that, while their returns become less risky as a target date is reached, both the final value that will be reached and the income that will be produced over the retirement period will be subject to considerable risk, both on the downside and upside. See, for example, “The Risks Within Target Date Funds,” (https://www.institutionalinvestor.com/article/b15bg9q27mzcwp/risk-within-target-date-funds).

None of the above and other available strategies and investment vehicles provide an investor with an advance ability to have an assured and reliable determination of monthly income over a given period of time such as during retirement years. These investment vehicles are all susceptible to institutions credit ratings, market volatility, etc.

### BRIEF DESCRIPTION OF THE DRAWINGS

In order to describe the manner in which advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example setting, according to one aspect of the present disclosure;

FIG. 2 illustrates an example timeline associated with an asset allocation scheme, according to one aspect of the present disclosure;

FIG. 3 illustrates an example method of asset management, according to one aspect of the present disclosure;

FIGS. 4A-E illustrate example screenshots of an asset management tool of FIG. 1, according to one aspect of the present disclosure; and

FIG. 5 illustrates example components of an asset management tool of FIG. 1, according to one aspect of the present disclosure.

### DESCRIPTION OF EXAMPLE EMBODIMENTS

Various example embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the example embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative example embodiments mutually exclusive of other example embodiments. Moreover, various features are described which may be exhibited by some example embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various example embodiments given in this specification.

Without intent to limit the scope of the disclosure, examples of instruments, apparatus, methods and their related results according to the example embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

For clarity of explanation, in some instances the present technology may be presented as including individual functional blocks including functional blocks comprising devices, device components, steps or routines in a method embodied in software, or combinations of hardware and software.

### Overview

The present disclosure describes a computerized platform/tool and methods implemented thereby, which enable a periodic adjustment in allocation of assets available in a fund between various investment vehicles to ensure that at any given time (1) a minimum agreed upon annual/monthly income over a given period of time is ensured for any of the fund's investors and (2) subject to satisfying condition (1), assets in the fund have the maximum possible exposure to equity markets.

In one aspect, an asset management tool configured to periodically adjust allocation of assets within a fund between different investment vehicles such that a desired minimum outcome for each investor is assured on a corresponding target date. The asset management tool includes one or more memories having computer-readable instructions stored therein and one or more processors. The one or more processors are configured to execute the computer-readable instructions to, at a given time, determine an updated net asset value of a fund, the net asset value of the fund being a result all contributions by a first number of investors to the fund less all withdrawals from the fund by a second number of investors; determine a current value of each share of the fund based on a corresponding value of each of the different investment vehicles; based on the current value of each share of the fund and a corresponding number of shares of the fund owned by each investor, adjust the allocation of the net asset value of the fund between the different investment vehicles such that for each investor, a minimum outcome consistent with the corresponding number of shares owned by each investor is assured starting at a corresponding target date; and initiate disbursement of the minimum outcome to each investor for whom the corresponding target date has been reached.

In one aspect, one or more non-transitory computer-readable medium have computer-readable instructions, which when executed by one or more processors, cause the one or more processors to provide an asset management tool to periodically adjust allocation of assets within a fund between different investment vehicles such that a desired minimum outcome for each investor is assured on a corresponding target date. The computer-readable instructions including instructions for determining an updated net asset value of a fund, the net asset value of the fund being a result of all contributions by a first number of investors to the fund less all withdrawals from the fund by a second number of investors; determining a current value of each share of the fund based on a corresponding value of each of the different investment vehicles; based on the current value of each share of the fund and a corresponding number of shares of the fund owned by each investor, adjusting the allocation of the net asset value of the fund between the different investment vehicles such that for each investor, a minimum outcome consistent with the corresponding number of shares owned by each investor is assured starting at a corresponding target date; and initiating disbursement of the minimum outcome to each investor for whom the corresponding target date has been reached.

### DETAILED DESCRIPTION

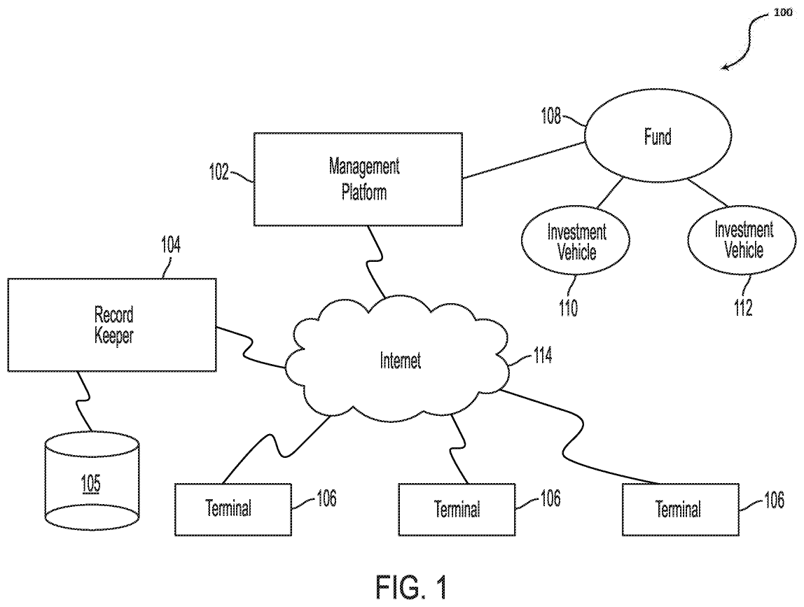

The disclosure now turns to FIG. 1, which describes a setting or a system in which inventive concepts of the present disclosure may be implemented. Prior to describing example embodiments of systems and methods of the present disclosure, a non-limiting example of the inventive concepts is described to aid in understanding of core concepts presented herein.

As noted above, a remaining and indeed a significant shortcoming of various available financial planning tools that individual investors rely upon to invest their assets for future purposes such as retirement, is their susceptibility to market volatilities and the inability of each and every one of them to provide an investor with an easy to understand and simple way of knowing an assured and exact payout in the future (over a defined period of time) for an exact amount of investment in a fund prior to reaching the defined period of time. For example, many financial planning tools that are currently available to investors provide the investors with an estimated analysis having an expected (not assured) outcome based on a current level of investment and statistical analysis of market conditions. For example, many financial planning tools used in conjunction with Individual Retirement Accounts (IRA) or 401K accounts, provide investors with a feature that given a current level of contribution to the investor's mutual fund account or 401K account, the investor can expect an estimated account balance of X amount at retirement. As stated, such X amount is only an estimate and is susceptible to a larger or complete wipeout both in the long term or the short term due to market volatility and unexpected downturns in financial markets. Furthermore, even if markets perform as expected until the individual investor reaches a target age of retirement, challenges remain for how best to use the available balance sustainably throughout the retirement years. Several examples of strategies used by currently available financial planning tools were described above, all of which have various deficiencies, the most critical of which is that none provide an investor with the ability to have an exact minimum amount of what their annual/monthly income from their investment would be during the defined period of time.

One main reason behind the deficiencies of available asset management and financial planning tools is that they operate on a collection of disjoint and distributed investment vehicles with no viable mechanism to provide a coherent and exact analysis of their performance and present users and investors with an assured desired outcome that is independent of adverse effects of market volatility while providing the users and investors with upside of positive market performance.

Examples provided herein provide an asset management tool and a centralized platform that analyzes various investment vehicles and improves asset allocation between the different available investment vehicles so as to ensure two outcomes for investors. The first outcome is an assured minimum monthly/annual payment (income) to each investor over a defined period of time. The second outcome is maximum exposure of the fund's investment in equity markets conditioned on meeting the first outcome.

This example asset management tool and centralized platform of the present application guarantees the two outcomes mentioned above by executing a set of computer-readable instructions to operate on a fund and manage allocation of assets of the fund between different investment vehicles and adjustment to number of shares of each investor in the fund. Shares of such fund may be purchased by individual investors.

For each new share of the fund that an investor purchases, the tool manages allocation of the available balance of the fund resulting from the purchase of the share, at any given time, between an equity fund and a U.S. treasury STRIPS fund (examples of two different investment vehicles) such that starting at a target date from the date of first purchase of a share (e.g., 10 years), each purchased share provides the investor with a minimum of $1 of annual income for a defined period of time (e.g., 20 years).

In one example, one of the two different investment vehicles is a “riskless” fund, which would be formed of securities with virtually zero or relatively minimal risk such as U.S. government debt (e.g., U.S. treasury STRIPS). However, other known or to be developed “riskless” funds may also be used instead of U.S. treasury STRIPS and fall within the scope of the present disclosure.

As the shares of the fund may be periodically purchased and sold by different investors, the available balance of the fund may periodically change. Accordingly and as will be described below, the asset management tool of the present application periodically adjusts allocation of the available balance in the two different investment vehicles such that for each investor, the two outcomes mentioned above are assured, even when market conditions are such that a portion of each investor's investment in the equity fund reaches a value of zero. These assured outcomes can never be provided by existing financial management tools available to investors as extreme under performance of equity markets invalidates every estimate and expected outcome that these financial management tools advertise or promise to investors. Details of this novel and advantageous tool presented herein will now be described with reference to FIGS. 1-5.

In one example, the periodicity with which shares of the fund may be purchased (or sold) and the allocation of assets between different investment vehicles adjusted may change depending on when a given investor decides to invest in a fund, when a given investor withdraws from the fund, changes in returns of each investment vehicle, etc. Multiple such purchases and/or withdraws may happen over a very short period of time (e.g., within a minute, an hour, a day, etc.) thus increasing the periodicity of the share purchase and the allocation of assets. In another example, there may be situations where no new purchases or withdrawals from the fund may take place for a relatively long period of time (hours, days, weeks, etc.), which in turn reduces the periodicity of share purchase (share sale) and allocation of assets decreases.

FIG. 1 illustrates an example setting, according to one aspect of the present disclosure. As shown in FIG. 1, setting 100 includes management platform (asset management or asset allocation tool) 102, record keeper (record keeping component) 104 and one or more terminals 106.

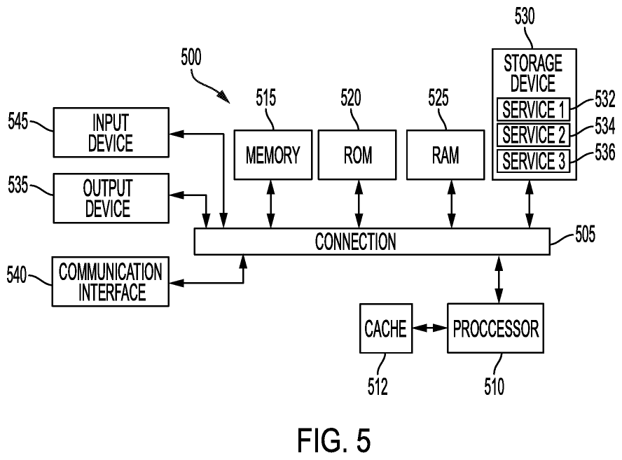

Management platform 102 may have one or more memories and processors, as will be described below with reference to FIG. 5.

Management platform 102 (asset management tool 102) may manage a fund 108. Fund 108, at any point in time and as will be described below, may have a balance. The balance may be a total sum of all contributions and withdrawals of investors to and from fund 108. By implementing computer-readable instructions stored in one or more associated memories, management platform 102 periodically manages/adjusts allocation of the total balance of fund 108 between various investment vehicles to ensure that at any given time (1) a minimum agreed upon annual/monthly income over a given period of time is ensured for a corresponding investor and (2) assets of the corresponding investor has maximum exposure to investment vehicle 112 (described below) that is consistent with assuring the agreed-upon minimum annual/monthly income of (1).

Fund 108 can be setup as any type of fund or trust including, but not limited to a mutual fund or a Collective Investment Trust (CIT). Available balance of fund 108 may be allocated between two or more investment vehicles 110 and 112. Fund 108 may also be referred to as Target Retirement Investment Plus (TRIP) fund.

Investment vehicle 110 may be U.S. Treasury Separate Trading of Registered Interest and Principal of Securities (STRIPS), which are examples of fixed-income securities sold at a discount to face value and offer no interest payments until their designated maturity date.

Investment vehicle 112 may be any type of financial product, known or to be developed, that are exchanged in markets around the globe. Investment vehicle 112 may itself be a collection of various types of exchanged asset classes. For example, investment 112 may comprise of U.S. and/or global stocks, foreign exchange (forex), bonds, derivatives, physical assets, etc. Investment vehicle 112 can have any type of known or to be developed fund structure such as exchange traded fund (ETF), mutual funds, etc. A portion of fund 108 invested in investment vehicle 112 may be referred to as a plus portion of TRIP fund.

Throughout this disclosure, any reference made to equities or equity funds is synonymous with any of example types or structures of investment vehicle 112 described above. In other words, equities or equity funds may be used as a non-limiting example of investment vehicle 112.

Record keeper 104 may the same entity as the entity operating management platform 102 or may be different. Record keeper 104 may be any commercially available trading platform through which individual investors using one or more of terminals 106 may buy or sell shares of fund 108. Using one or more of terminals 106, each investor may log into his or her corresponding account with record keeper 104, search for ticker of fund 108 (e.g., TRIP, TRP, etc.) and buy one or more shares thereof. Price of each share fund 108 may fluctuate daily, weekly, monthly, annually, etc., depending on variations in prices of STRIPS bonds and equity markets.

Examples of terminals 106 can be any known or to be developed device capable of establishing wired/wireless connection to other components of setting 100 (using any known or to be developed wired/wireless communication medium or protocol) via internet 114.

Management platform 102 may be hosted on a public, private and/or hybrid cloud structure and can be accessible via one or more of terminals 106 by a corresponding operator.

Having described an example setting 100 in which management platform 102 may operate to implement an asset allocation scheme of the present application, the disclosure now turns to describing examples of asset allocation scheme. A graphical timeline and several numerical examples of such asset allocation scheme will be described below.

First we define several key characteristics of the fund. A purchase date is a date on which an individual investor purchases one or more shares of fund 108 for the first time. The price of a share may fluctuate over time depending on performance of various investment vehicles such as U.S. Treasury STRIPS bonds and equity markets. A target date is a date on which 20 annual payments of a minimum of $1 per year starts for each purchased share. An example target date is 10 years from the purchase date. However, other target dates may also be set based on experiments, simulations and/or empirical studies (e.g., 5 years). A period from the purchase date to the target date may be defined as an accumulation period or contribution period. The accumulation period is a period in which an investor should buy a number of shares that are equivalent to the desired annual income for 20 years starting on the target date. Therefore, if an investor desires an annual assured payment of $10,000 for 20 years starting 10 years from Jan. 1, 2019, the investor should purchase 10,000 shares of fund 118 from Jan. 1, 2019 to Dec. 31, 2028 and the annual payment of $10,000 per year starts on Jan. 1, 2029 until Jan. 1, 2048. The 20 annual payments are just examples used for illustrative purposes. However, the present application is not limited to 20 annual payments. For example, the annual payments can be fewer or more (e.g., 5 years, 10 years, 15 years, 25 years, etc.).

Proceeds of sale of each share of fund 108 may be allocated as follows. Initially, 80% of the proceeds are invested in what may be referred to as a STRIP ladder, which is a sequence of 20 U.S. Treasury STRIPS with maturity dates starting at the target date and lasting for 20 years. In other words, 80% of the proceeds are invested in 20 different annual U.S. Treasury STRIPS, each of which matures in a different year over the 20 years of payout.

Remaining 20% of the proceeds are invested in investment vehicle 112, which will have a market value at the target date. This may be referred to as a plus portion of the proceeds, the value of which fluctuates with markets in which this portion may be invested from the purchase date up to the target date.

It should be noted that the example of 80% and 20% allocation is non-limiting and such percentages may be modified for new funds according to various factors such as market conditions, experiments and/or empirical studies.

Depending on returns of each investment vehicle and fluctuations in net balance of fund 108 at any given time due to contributions and withdrawals of investors, the 80%/20% allocation is adjusted by management platform 102 to meet the above recited conditions (i.e., that at any given time (1) a minimum agreed upon annual/monthly income over a given period of time is ensured for a corresponding investor and (2) assets of fund 108 has maximum exposure to investment vehicle 112 that is consistent with assuring the agreed-upon minimum annual/monthly income of (1).

At target date, the balance of the plus portion may then be transferred to the corresponding investor to be managed thereby according to any desired spending or investment method. In one example, the investor may be given the option to have management platform 102 to invest the balance of the plus portion in what may be referred to as Qualified Longevity Annuity Contract (QLAC).

Another advantage provided by asset management tool of the present application is that there is no constraint on any investor's investment in the fund during the period from the purchase date to the target date. In other words, at any given time, an investor may simply sell his or her share in the fund and receive proceeds of the sale without any penalties (as opposed to the case with annuities, where investors pay a penalty for early withdrawals).

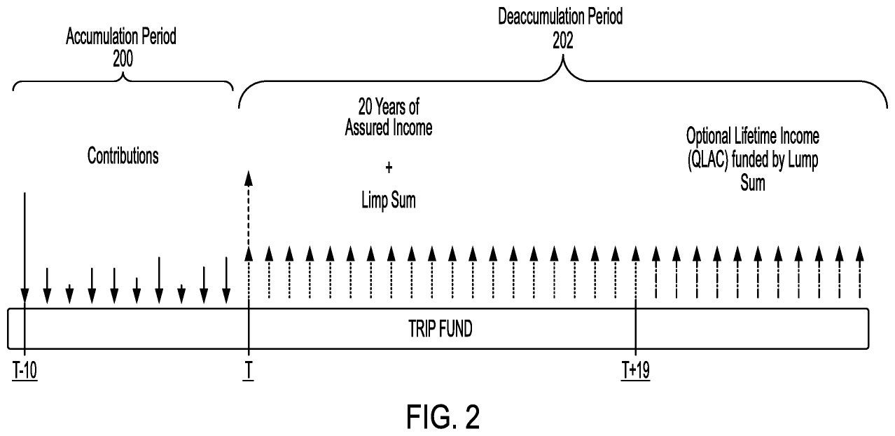

FIG. 2 illustrates an example timeline associated with an asset allocation scheme, according to one aspect of the present disclosure. In FIG. 2, T represents the target date defined above, T−10 represents the purchase date described above and T+19 represents the date on which annual payments to an investor from fund 108 terminates.

As shown in FIG. 2, contribution or accumulation period 200 starts at date T−10 to T−1, during which an investor can purchase a number of shares of fund 108 corresponding to a desired amount of income during payout period 202. Payout period 202 starts on date T until T+19 and beyond. Payout period or decumulation period 202 includes a 20 year period of assured income (corresponding to $1 per share of fund 118 purchased by any investor during accumulation period 200). Shown in timeline of FIG. 2 is also a lump sum payment corresponding to the plus portion of an investor's assets (e.g., 20% described above) to the investor on target date T, which may be used to purchase, for example QLAC beyond date T+19 during payout period 202 or may be used as an investor wishes.

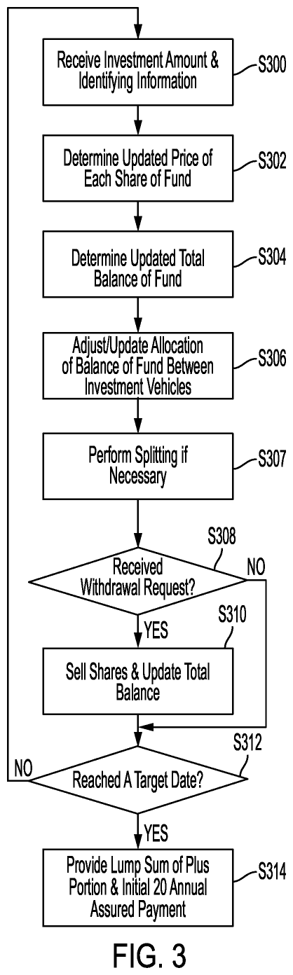

Management platform 102 of the present application implements an algorithm, which will be described below with reference to FIG. 3 that may periodically adjust allocation of assets within fund 108 between example investment vehicles 110 and 112 (e.g., U.S. Treasury STRIPS and equity funds) such that a desired income of each investor in fund 108 during a 20 year period from target date is assured while maximum exposure to investment vehicle 112 is provided to each investor (i.e., maximum amount possible is allocated to the plus portion for each investor). A numerical example of such algorithm is provided first followed by a detailed description of the algorithm with reference to FIG. 3.

For purposes of a simplified numerical example, the following assumptions are made. Investors A and B invest in fund 108 at time periods 1 and 2, respectively (e.g., Jan. 1, 2019 and Jun. 1, 2019). A price of a STRIP ladder providing an assured annual income of $1200 for 20 years starting on Jan. 1, 2029, which is 10 years from time period 1 Jan. 1, 2019), is $1,600. A price of a share of equity is $400 on Jan. 1, 2019. A sum of the price of a single STRIP ladder and a single share of equity defines a total price of one share of fund 108 at any given time. In this example, a single share of fund 108 costs $2000 on Jan. 1, 2019 ($1,600+$400). Investor A invests $2,000 in fund 108 on Jan. 1, 2019 to buy one share of fund 108. Accordingly, investor A owns 100% of fund 108 on Jan. 1, 2019.

Accordingly, on Jan. 1, 2019, management platform 102 performs asset allocation between investment vehicles 110 and 112 such that 80% of assets in fund 108 (i.e., $1,600) is allocated to purchase of a STRIP ladder in investment vehicle 110 while the remaining 20% (e.g., $400) is allocated to investment vehicle 112.

Return on investment of each of investment vehicles 110 and 112 on Jun. 1, 2019 may be 0 and −10%, respectively. In other words, on Jun. 1, 2019, a price of a STRIP ladder providing an assured annual income of $1200 for 20 years starting on Jun. 1, 2029, which is 10 years from time period 2 of Jun. 1, 2019), is still $1,600, while a price of each share of equity is now $360 due to the negative return of 10% of investment vehicle 112. Accordingly, on Jun. 1, 2019, a price of each share of fund 108 is $1,960 compared to $2,000 on Jan. 1, 2019.

At time period 2, investor B invests $2,000 in fund 108, which translates into investor B having purchased 1.02 shares of fund 108 ($2,000/$1,960). At this point, total asset and available balance (net asset value) of fund 108 is $3,960 ($1,960+$2,000). Because investor A has purchased 1 share of fund 108 and investor B has purchased 1.02 shares of fund 108, the allocation of balance of fund 108 at time period 2 should be such that 2.02 (1+1.02) STRIP ladders are held (2.02*$1,600 that is a price of each STRIP ladder on Jun. 1, 2019). Accordingly, instead of a simple 80% allocation of balance of fund 108 in investment vehicle 110 and 20% of balance of fund 108 in investment vehicle 112 (as was done at time period 1 above), management platform 102 allocates 81.6% of the balance of fund 108 ($3,232.6) in investment vehicle 110 and 18.4% of the balance of fund 108 in investment vehicle 112 in order to meet the assured annual income of $1200 for investor A and assured annual income of $1,200 for investor B. In this example investor B ends up with a larger assured amount of $1,224. At this point investor A owns 49.5% of fund 108 while investor B owns 50.5% of fund 108.

The above adjustment to allocation of balance of fund 108 is periodically carried out depending on return of investment of each investment vehicle and contribution/withdrawal of assets by various investors to and from fund 108.

In yet another example, management platform 102 performs a split process (or a share split process) to assure that each share owned by any investor, at any given time, assures annual/monthly payments of 1 dollar per share (may be referred to as a 1 share-1 dollar constraint) for 20 years. Below is an example of a split process to adhere to the 1 share-1 dollar constraint.

For purposes of a simplified numerical example, the following assumptions are made. Investors A and B invest in fund 108 at time periods 1 and 2, respectively (e.g., Jan. 1, 2019 and Jun. 1, 2019). The cost of a share of fund 108 is $100. In this example, cost of a share in investment vehicle 110 (U.S. treasury STRIPS) paying $1 per year for 20 years is $80. At time period 1, investor A purchases one share of fund 108 for $100 and management platform 102 allocates $80 dollars in investment vehicle 110 (U.S. treasury STRIPS) and $20 in investment vehicle 112.

From time period 1 to time period 2 (e.g., Jan. 1, 2019 to Jun. 1, 2019), the return on investment vehicle 110 (price of a STRIP ladder) is unchanged while the return of investment vehicle 112 has doubled (from $20 to $40). Also at this time and before any new investment at time period 2, the total balance of fund 108 is $120.

At time period 2, investor B invests $100 in fund 108. Immediately prior to the new $100 investment hitting fund 108, the $120 is rebalanced to adhere to the example 80/20% allocation between investment vehicles 110 and 112 and thus $96 (80% of $120) is allocated to investment vehicle 110 and $24 (%20 of $120) is allocated to investment vehicle 112.

Upon receiving the new deposit/investment of $100 at time period 2, fund 108 would have a balance of $220. Management platform 102 performs a split process such that a single share of fund 108 (immediately prior to the new investment of $100 at time period 2) is split into 1.20 shares after receiving the new investment of $100 such that investor A now owns 1.20 share of fund 108 while investor B owns a single share of fund 108. In other words, fund 108 would have 2.2 outstanding shares after the investment by investor B as opposed to simply two shares, ensuring that each investor will receive at least $1 per share for 20 years. It should be noted that while investors A and B are referred to above, investor B at time period 2 can simply be the same investor A. In other words, instead of a new investor B, at time period 2, investor A can make a new contribution to (make a new investment in) fund 108.

With above non-limiting example in mind, algorithm implemented by management platform 102 will be described with reference to FIG. 3. FIG. 3 illustrates an example method of asset management, according to one aspect of the present disclosure. FIG. 3 will be described from perspective of management platform 102 of FIG. 1. However, it will be understood that management platform 102 has one or more memories on which computer readable instructions are stored, which when executed by one or more associated processors, configure the one or more associated processors to implement steps described with reference to FIG. 3.

At S300, management platform 102 receives an investment amount and identifying information of an investor. Identifying information may include, but is not limited to, an investors name, age, a desired assured income starting at target date for 20 consecutive years, a number of shares purchased by the investor, date of investment, etc. In one example, investment amount and identifying information of the investor may first be received by record keeper 104 when the investor initially puts in a request to invest in fund 108. Record keeper 104 may store this information in a database such as database 105 associated with record keeper 104.

At S302, management platform 102 determines a current and updated price of each share of fund 108. As described above with reference to the non-limiting numerical example, at any given time, a current price of each share of fund 108 may be determined as a sum of a cost of a STRIP ladder that provides the desired assured income for the investor and a cost of a share of investment vehicle 112.

At S304, management platform 102 determines a total balance (net asset value) of fund 108, which may be the sum of all existing contributions to and withdrawals from fund 108 by investors including the most recent investment by the investor received at S300.

At S306, management platform 102 adjusts and updates allocation of portions of the total balance between investment vehicles 110 and 112 (e.g., between STRIP ladders and investment vehicle 112) such that for each current investor in fund 108 a number of STRIP ladders is held for each investor corresponding to a current number of shares of fund 108 owned by the corresponding investor while remaining portion of the total balance of fund 108 is invested in investment vehicle 112. This adjustment and allocation of the total balance is based on an investment rule that management platform 102 determines at any given point in time (denoted by Fₜ) for investing a fraction of the total balance in investment vehicle 110 (STRIP fund) to satisfy the assurance (minimum assured annual/monthly income for 20 years starting at 10 years from the date proceeds of sale of shares of fund 108 is received from an investor).

A non-limiting numerical example of the adjustment and allocation of the total balance of fund 108 at S306 is described above. A general frame work based on which this adjustment and allocation is carried out by management platform 102 is as follows.

The formal assurance offered by management platform 102 is that the income generated during 20 years is at least 80% of the income an investor would receive if they had invested 100% of their savings in U.S. government STRIPs, net of the value of the withdrawals from the fund.

Because the value of a STRIP ladder is proportional to the income it provides for the number of years it covers, the formal assurance can be equivalently defined as management platform 102 assuring that an investor's position in investment vehicle 110 will never fall below a predetermined percentage of the value of a riskless contribution fund, net of the value of the withdrawals fund. Defining p E [0, 1] (i.e., p has a value between zero (0) and one (1)) as the percentage below which the TRIP fund will not fall below (floor of TRIP fund 108), and V_{i,t} as the value of an individual's investment in the TRIP fund, the assurance can be expressed mathematically, at any given time, as:

Vi,t≥pCi,t−Wi,t∀tE[0,T] (1)

Where C_{i,t} is a “hypothetical” riskless contribution fund that invests all of an individual's contributions in the STRIP fund (investment vehicle 110), where C stands for contributions, i denotes an individual, and t denotes time of investment. Furthermore, W_{i,t} is a “hypothetical” riskless withdrawals fund that invests all of an individual's withdrawals in the STRIP fund, where W stands for withdrawals, i denotes the individual, and t denotes the time of investment).

As noted above, Fₜ must satisfy the assured income for each investor. To derive Fₜ at any given time, an assumption is made that equation (1) is satisfied for t and the aim is now to satisfy equation (1) for t+1. To do so, a couple of variables are introduced and defined first.

Let W_{i,t} be the weight of individual i at time t in fund 108 (percentage of ownership of fund 108), Vₜ the value of fund 108 at time t (total balance at time t), and fₜ∈(0, 1] the weight of STRIPs in the fund at time t. Also, define I_{i,t} as the contribution (or withdrawal if less than 0) of investor i at time t. Therefore, the aggregate of the individual's contribution may be given by:

Iₜ=Σᵢ₌₁ⁿl_{i,t} (2)

We further denote, return of fund 108 between time t and t+1 as Rₜ₊₁^{f}, return of investment vehicle 110 (STRIP fund) as Rₜ₊₁^{S}, Vₜ₊₁⁻ as the value of fund 108 in investment vehicle 110 and fₜ₊₁⁻ as the corresponding fraction of fund 108 in investment vehicle 110. Accordingly, value of fund 108 before new contribution(s) at time t+1 is the value of fund 108 at time t multiplied by its returns and given by:

Vₜ₊₁⁻=VₜRₜ₊₁^{f} (3)

Fraction of fund 108 invested in STRIP ladders at t+1, before contribution(s), is given by:

$${f}_{t + 1}^{-} = \frac{{V}_{t} {f}_{t} {R}_{t + 1}^{S}}{{V}_{t + 1}^{-}} \qquad ( 4 )$$

Fraction of fund 108 invested in STRIP ladders at t+1 as a function of investment rule Fₜ is given by:

$${f}_{t + 1} = \frac{{V}_{t + 1}^{-} {f}_{t + 1}^{-} + {F}_{t + 1} {I}_{t + 1}}{{V}_{t + 1}} \qquad ( 5 )$$

Value of fund 108 after contributions at t+1 is the value of fund 108 immediately before contributions plus the value of net of contributions less withdrawals and is given by:

Vₜ₊₁=Vₜ₊₁⁻+Iₜ₊₁ (6)

An individual's present value of contributions and withdrawals immediately before a new contribution at time t+1 is the value of contributions at time t adjusted by the return of the STRIP ladder(s) (investment vehicle 110) and given by:

C_{i,t+1}⁻=C_{i,t}Rₜ₊₁^{S} (7)

W_{i,t+1}⁻=W_{i,t}Rₜ₊₁^{S} (8)

An individual's value of contributions after a new contribution or withdrawal at t+1 is given by:

C_{i,t+1}=C_{i,t+1}⁻+max(I_{i,t+1},0) (9)

W_{i,t+1}=W_{i,t+1}⁻−min(I_{i,t+1},0) (10)

Weight of investor i at time t+1 is given by the investor's contributions and every other investors' contributions and is given by:

$${w}_{i , t + 1} = \frac{{w}_{i , t} {V}_{t + 1}^{-} + {I}_{i , t + 1}}{{V}_{t + 1}^{-} + {I}_{t + 1}} \qquad ( 11 )$$

With the above definitions, the following condition given by equation (12) must be satisfied at all times to meet the assured income desired by each investor even if the value of investment in investment vehicle 112 falls to zero. The condition is given by equation (12) below:

w_{i,t}Vₜfₜ≥pC_{i,t}−W_{i,t} (12)

Utilizing equations (1)-(12), management platform 102 can implement three different example algorithms to perform the adjustment and allocation of assets between funds at S306. Each of these algorithms require a certain level of knowledge regarding history of contributions and withdrawals by investors. The first algorithm requires knowledge of the entire history of contributions and withdrawals of each investor, the second algorithm requires knowledge of the weights of investors in fund 108 but not necessarily the history of contributions and withdrawals and the third algorithm requires observation of only prices of various investment vehicles and not the history or weights.

The first algorithm is as follows. Assurance of equation (12) for all investors with non-zero weights is given by:

w_{i,t+1}Vₜ₊₁fₜ₊₁≥pC_{i,t+1}−W_{i,t+1} (13)

Substituting fₜ₊₁ in equation (13) with equation (5) and a simplification, results in:

$${w}_{i , t + 1} {V}_{t + 1} = \frac{{V}_{t + 1}^{-} {f}_{t + 1}^{-} + {F}_{t + 1} {I}_{t + 1}}{{V}_{t + 1}} \geq {pC}_{i , t + 1} - {W}_{i , t + 1} \\ {V}_{t + 1}^{-} {f}_{t + 1}^{-} + {F}_{t + 1} {I}_{t + 1} \geq \frac{{pC}_{i , t + 1} - {W}_{i , t + 1}}{{w}_{i , t + 1}} \qquad ( 14 )$$

Let F_{i,t} be the Fₜ such that equation (12) is satisfied for investor i. Then, for all t+1 such that Iₜ₊₁ is not zero, assurance would be satisfied if:

$${F}_{i , t + 1} \geq \frac{{pC}_{i , t + 1} - {W}_{i , t + 1}}{{w}_{i , t + 1} {I}_{t + 1}} - \frac{{V}_{t + 1}^{-} {f}_{t + 1}^{-}}{{I}_{t + 1}} if {I}_{t + 1} > 0 \\ {F}_{i , t + 1} \leq \frac{{pC}_{i , t + 1} - {W}_{i , t + 1}}{{w}_{i , t + 1} {I}_{t + 1}} - \frac{{V}_{t + 1}^{-} {f}_{t + 1}^{-}}{{I}_{t + 1}} if {I}_{t + 1} < 0 \qquad ( 15 )$$

Therefore, the investment rule of S306 would be given by:

| | | |
|---|---|---|
| Fₜ₊₁ = max{F_{i, t+i}} | if Iₜ₊ᵢ > 0 | (16) |
| Fₜ₊₁ = min{F_{i ,t+i}} | if Iₜ₊ᵢ < 0 | (17) |

The second algorithm is as follows. Assurance of equation (12) for all investors with non-zero weights is given by:

w_{i,t+1}Vₜ₊₁fₜ₊₁≥pC_{i,t+1}−W_{i,t+1} (18)

Using equations (7), (8), (9) and (11), equation (2) can be rewritten as:

$$\begin{matrix}{pC}_{i , t + 1} - {W}_{i , t + 1} = & p ( {C}_{i , t} {R}_{t + 1}^{s} + max ( {I}_{i , t + 1} , 0 ) ) - \\ & ( {W}_{i , t} {R}_{t + 1}^{S} - min ( {I}_{i , t + 1} , 0 ) ) \\ = & ( {pC}_{i , t} - {W}_{i , t} ) {R}_{t + 1}^{S} + p max ( {I}_{i , t + 1} , 0 ) + \\ & min ( {I}_{i , t + 1} , 0 ) \leq \\ & {w}_{i , t + 1} {V}_{t} {f}_{t} {R}_{t + 1}^{S} + p max ( {I}_{i , t + 1} , 0 ) + \\ & min ( {I}_{i , t + 1} , 0 )\end{matrix} \qquad ( 19 )$$

Thus setting

w_{i,t+1}Vₜ₊₁fₜ₊₁≥w_{i,t+1}VₜfₜRₜ₊₁^{S}+pmax(I_{i,t+1}0)+min(I_{i,t+1}0) (20)

will satisfy the assured minimum income by management platform 102. Now substituting equation (5) into equation (20) and simplifying results in:

$${w}_{i , t + 1} {V}_{t + 1} \frac{{V}_{t + 1}^{-} {f}_{t + 1}^{-} + {F}_{t + 1} {I}_{t + 1}}{{V}_{t + 1}} \geq {w}_{i , t + 1} {V}_{t} {f}_{t} {R}_{t + 1}^{S} + p max ( {I}_{i , t + 1} , 0 ) + min ( {I}_{i , t + 1} , 0 ) \qquad ( 21 )$$

Solving for F_{i,t+1} in Equation (21) results in:

$${F}_{i , t + 1} \geq \frac{{w}_{i , t + 1} {V}_{t} {f}_{t} {R}_{t + 1}^{S} + p max ( {I}_{i , t + 1} , 0 ) + min ( {I}_{i , t + 1} , 0 )}{{w}_{i , t + 1} {I}_{t + 1}} - \frac{{V}_{t + 1}^{-} {f}_{t + 1}^{-}}{{I}_{t + 1}} if {I}_{t + 1} > 0 \\ {F}_{i , t + 1} \leq \frac{{w}_{i , t + 1} {V}_{t} {f}_{t} {R}_{t + 1}^{S} + p max ( {I}_{i , t + 1} , 0 ) + min ( {I}_{i , t + 1} , 0 )}{{w}_{i , t + 1} {I}_{t + 1}} - \frac{{V}_{t + 1}^{-} {f}_{t + 1}^{-}}{{I}_{t + 1}} if {I}_{t + 1} < 0 \qquad ( 22 )$$

Therefore, the investment rule of S306 would be given by:

| | | |
|---|---|---|
| Fₜ₊₁ = max{F_{i, t+i}} | if Iₜ₊ᵢ > 0 | (23) |
| Fₜ₊₁ = min{F_{i ,t+i}} | if Iₜ₊ᵢ < 0 | (24) |

The third algorithm will be described within the context of two example scenarios, one is that returns on investment vehicle 112 are low while the other one is that the returns on investment vehicle 112 are high. Considering the low returns case (fₜ₊₁⁻≥p)

w_{i,t+1}Vₜ₊₁fₜ₊₁≥pC_{i,t+1}−W_{i,t+1} (25)

Which using equation (20) implies the following inequality:

w_{i,t+1}Vₜ₊₁fₜ₊₁≥w_{i,t+1}VₜfₜRₜ₊₁^{S}+pmax(I_{i,t+1},0)+min(I_{i,t+1},0) (26)

Given the case of fₜ₊₁⁻≥p:

fₜ₊₁⁻I_{i,t+1}≥pmax(I_{i,t+1},0)+min (I_{i,t+1},0) (27)

Using equation (4) and equation (27) implies:

w_{i,t}Vₜ₊₁⁻fₜ₊₁⁻+f_{i,t}⁻l_{i,t+1}≥w_{i,t+1}VₜfₜRₜ₊₁^{S}+pmax(I_{i,t+1}0)+min(I_{i,t+1},0) (28)

Therefore, the following inequality satisfies the assurance requirement:

w_{i,t+1}Vₜ₋₁fₜ₊₁≥w_{i,t}Vₜ₊₁⁻fₜ₊₁⁻+fₜ₊₁⁻I_{i,t+1} (29)

Using equation (14), reduces equation (29) to:

w_{i,t+1}Vₜ₊₁fₜ₊₁≥w_{i,t}Vₜ₊₁⁻fₜ₊₁⁻+fₜ₊₁⁻I_{i,t+1}

≥fₜ₊₁⁻(w_{i,t}Vₜ₊₁⁻+I_{i,t+1})

≥fₜ₊₁⁻w_{i,t+1}Vₜ₊₁⁻

fₜ₊₁≥fₜ₊₁⁻ (30)

Therefore, using equations (5) and (6), the investment rule of S306 would be given by:

Fₜ₊₁=fₜ₊₁⁻ (31)

Investment rule given by equation (31) implies that management platform 102 invests (or disinvests) any new contributions to fund 108 by allocation to the investment vehicle 110 (STRIPS fund) the same proportion as fund 108 currently holds in STRIPS (prior to the new contribution) if the current weight of portion of fund 108 invested in STRIPS is greater than p.

Considering the high returns case (fₜ₊₁⁻<p) and starting from equation (26):

w_{i,t+1}Vₜ₊₁fₜ₊₁≥w_{i,t+1}VₜfₜRₜ₊₁^{S}+pmax(I_{i,t+1},0)+min(I_{i,t+1},0) (32)

Using equation (4) and equation (32) implies:

w_{i,t+1}Vₜ₊₁fₜ₊₁≥w_{i,t+1}Vₜ₊₁⁻fₜ₊₁⁻+pmax(I_{i,t+1},0)+min(I_{i,t+1},0) (33)

Using p≤1 and fₜ₊₁⁻<p:

w_{i,t+1}Vₜ₊₁⁻fₜ₊₁⁻+pmax (I_{i,t+1},0)+min (I_{i,t+1},0)≤w_{i,t}V_{i,t+1}⁻fₜ₊₁⁻+pmax(I_{i,t+1},0)+pmin(I_{i,t+1},0)

≤w_{i,t}Vₜ₊₁⁻fₜ₊₁⁻+p(max(I_{i,t+1},0)+min(I_{i,t+1},0))

≤w_{i,t}Vₜ₊₁⁻fₜ₊₁⁻+pI_{i,t+1}

≤w_{i,t}Vₜ₊₁⁻p+pI_{i,t+1} (34)

Substituting equation (34) into equation (33) results in:

w_{i,t+}Vₜ₊₁fₜ₊₁≥w_{i,t}Vₜ₊₁⁻p+pI_{i,t+1} (35)

Which can be simplified as follows:

w_{i,t+1}Vₜ₊₁fₜ₊₁≥w_{i,t+1}Vₜ₊₁p

fₜ₊₁≥p (36)

fₜ₊₁≥p as shown in equation (36) satisfies the assured income of fund 108 and choosing fₜ₊₁=p will also satisfied the assured income while maximizing exposure of the plus portion of an investor's assets to investment vehicle 112.

Finally, using equations (5), the investment rule of S306 would be given by:

$${F}_{t + 1} = p + \frac{{V}_{t + 1}^{-}}{{I}_{t + 1}} ( p - {f}_{t + 1}^{-} ) \qquad ( 37 )$$

Investment rule given by equation (37) does not depend on any given investor's position or ownership of fund 108 and simply dependent on market prices of different investment vehicles (STRIPS bonds 110 and investment vehicle 112) and net contributions or withdrawals from fund 108.

Investment rule given by equation (37) implies that management platform 102 invests (or disinvests) any new contributions to fund 108 by allocation to the investment vehicle 110 (STRIPS fund) the same proportion as fund 108 currently holds in STRIPS (prior to the new contribution) if the current weight of portion of fund 108 invested in STRIPS is greater than p and allocates so that the ex-contributions weight of STRIPS in fund 108 is p if the current weight of portion of fund 108 invested in STRIPS is lower than p.

While several example algorithms are described above using which management platform 102 can determine how best to adjust and allocate assets between investment vehicles 110 and 112 to meeting performance requirements of fund 118, in one example the third algorithm presents the least complex and data intensive of the three example algorithms, as knowledge of history of an investor's contributions and withdrawals are not needed.

Referring back FIG. 3 and after management platform 102 adjusts and updates allocation of balance of fund 108 between investment vehicles 110 and 112, at S307, management platform 102 performs splitting if necessary. In one example, splitting is necessary if a portion of balance of fund 108 in investment vehicle 112 is greater than a threshold. In examples of 80/20% allocation scheme described in this disclosure, the threshold is the 20% allocation to investment vehicle 112. However, if other allocation schemes (e.g., 70/30%) is used, the threshold would be the 30% allocation. The splitting may be performed to adhere to the 1 share-1 dollar constraint described with an example above.

Thereafter, at S308, management platform 102 determines if a withdrawal request from an investor is received. If a withdrawal request is received, at S310, management platform 102 sells a corresponding number of shares of fund 108 that is currently owned by the investor from whom the withdrawal request is received. Upon completion of the sale, the proceeds of the share are sent to record keeper 104 for ultimate transfer to the investor's account with record keeper 104. Record keeper 104 updates database 105 accordingly.

However, if a withdrawal request is not received at S308, at S312, management platform 102 determines if a target date (described with reference to timeline of FIG. 2) has been reached for any given investor currently owning shares of fund 108. If not, the process reverts back to S300 and management platform 102 repeats S300 to S312. If yes, at S314, management platform 102, for the investor for whom the target date has been reached and assuming that such investor owns a non-zero portion of fund 108 (i.e., still has investment in fund 108 at the corresponding target date), provides a lump sum corresponding to proceeds of sale of a portion of the investor's shares invested in investment vehicle 112 (plus portion) and initiates 20 annual payments each of which is equivalent to the number of shares of fund 108 owned by the investor at the target date. The records of the investor are then updated by record keeper 104 in database 105 upon payment of the lump sum and/or any of the annual payouts. As mentioned above, the lump sum can be used as desired by the corresponding investor an example of which may be purchase of QLAC. In another example, the lump sum can be transferred to an IRA account of the corresponding investor.

In one example, processes of S308 and S310 may be combined with S300 and performed initially such that management platform 102 can have more holistic view of all contributions and withdrawals from fund 108 initially followed by performing remaining steps of FIG. 3.

Management platform 102, by implementing the process of FIG. 3 and periodic adjustment to allocation of balance of fund 108 between different investment vehicles described above, provides a technological solution using computer-implemented algorithms that optimizes asset allocation such that certain results or outcomes are assured for investors in fund 108. As described, this unique asset allocation tool ensures the desired outcome for each investor (i.e., the assured minimum annual income described above) regardless of fluctuations in market conditions, net asset value/total balance of fund 108 resulting from contributions/withdrawal of investments by any investor in fund 108, etc. The periodic analysis of fluctuations of values of various investment vehicles and using the results of such analysis to optimize asset allocation, provides a secure and easy to use tool for an asset manager to reliably track investment of balance of fund 108 without having to perform any manual or separate and independent analysis of different investment vehicles and allocation of assets thereto.

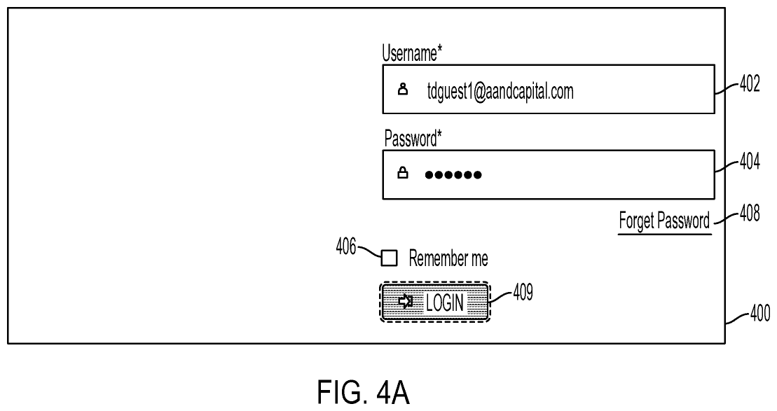

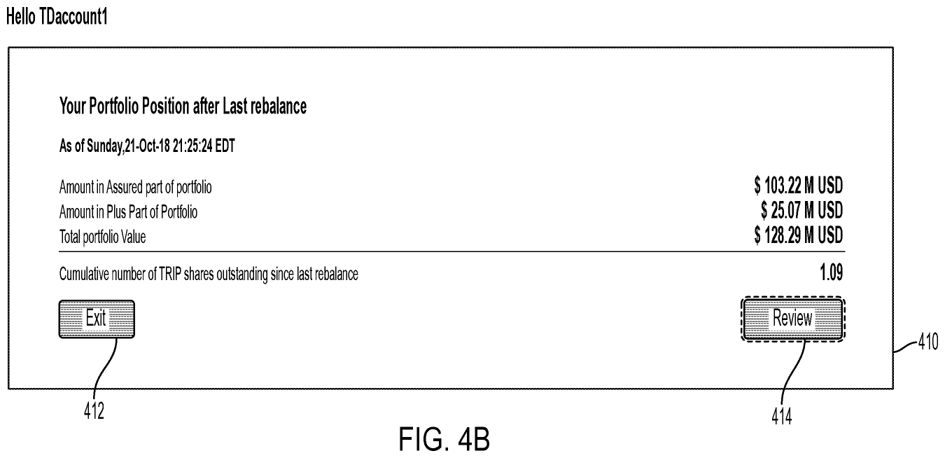

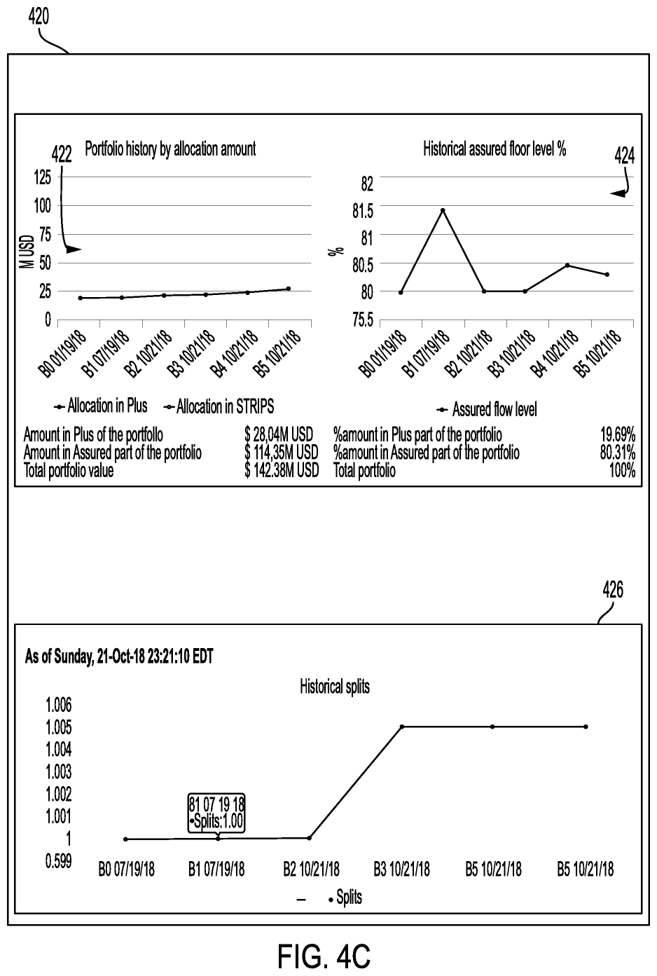

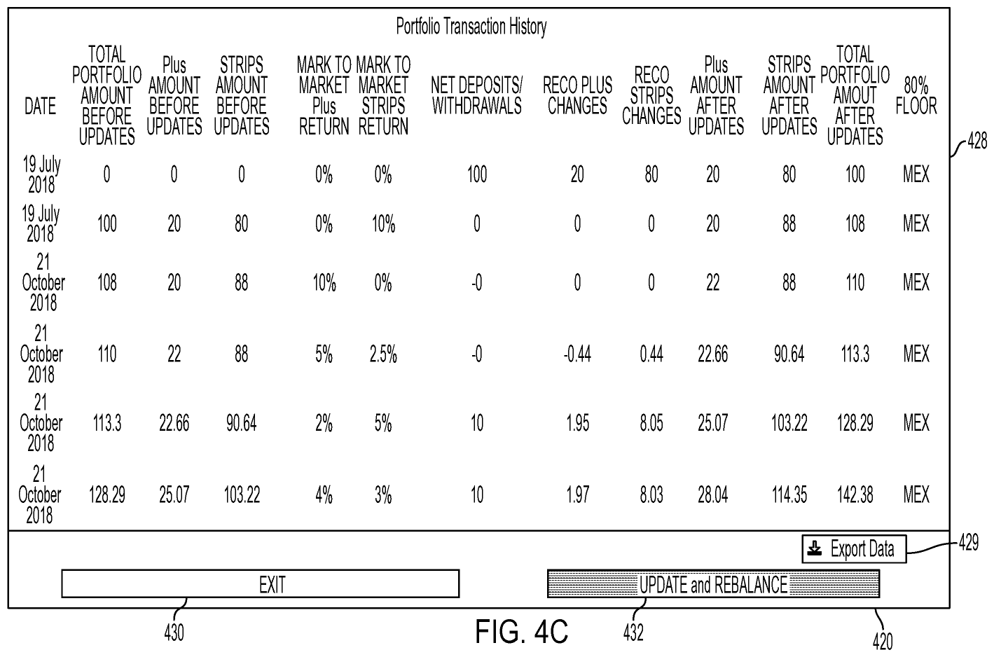

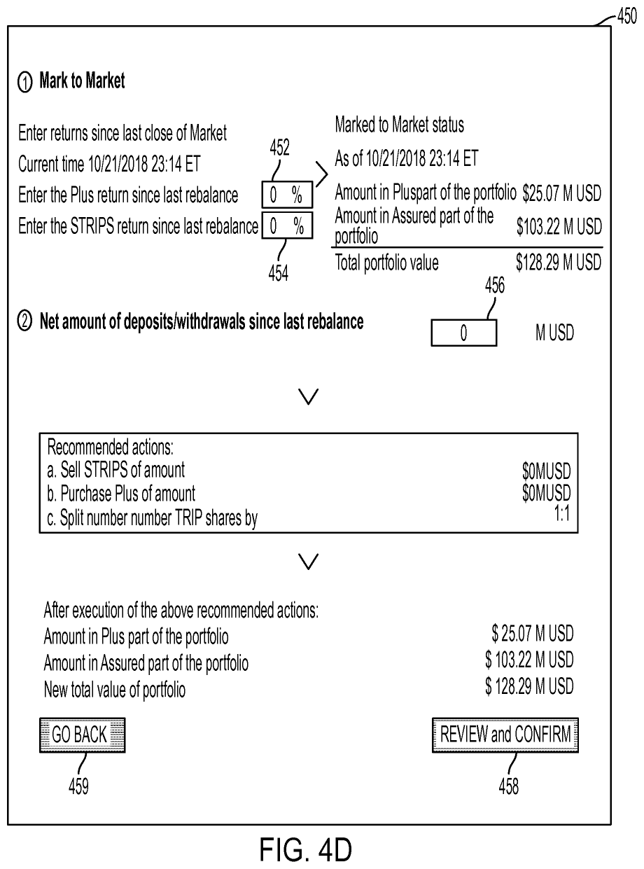

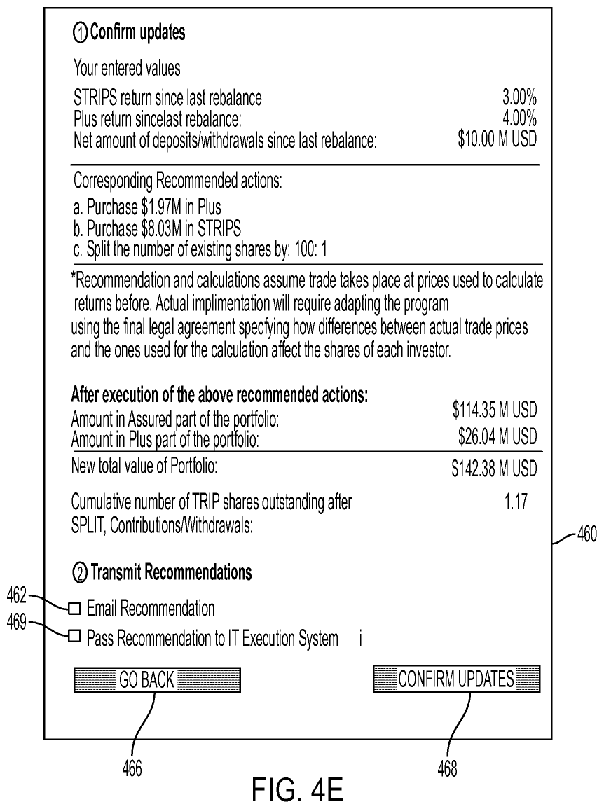

Management platform 102 may be accessible to an operator thereof via a graphical user interface (GUI), various aspects thereof will be described below with reference to FIGS. 4A-E.

FIGS. 4A-E illustrate example screenshots of an asset management tool of FIG. 1, according to one aspect of the present disclosure.

FIG. 4A illustrates a login GUI 400, using which, an operator of management platform 102 can enter his or her credentials (username and password in fields 402 and 404) to access and manage fund 108. Such operator may register with record keeper or provider of management platform 102 to obtain access thereto. GUI 400 may also provide option 406 for the operator to have his or her credentials remembered by a terminal such as one of terminals 106 through which the operator is attempting an access to management platform 102 and/or option 408 to recover lost/forgotten credentials. GUI 400 also provides option 409, which when activated, authorized and directs the operator to other GUIs for interacting with management platform 102.

FIG. 4B illustrates GUI 410, which provides a snapshot/summary of fund 108 (identified as portfolio in GUI 410) as of any given time including a breakdown of current portions of fund 108 invested in the different example investment vehicles (U.S. STRIPS bonds labeled as “Amount in Assured part of portfolio” and investment vehicles labeled as “Amount in Plus part of portfolio”). GUI 410 may be displayed upon a successful login by operator using GUI 400. GUI 410 presents option 412 for the operator to exit management platform 102 or to review details of fund 108 using option 414.

FIG. 4C illustrates GUI 420, which may be displayed on a screen of terminal 106 when the operator selections option 414 on GUI 410. As can be seen from FIG. 4C, GUI 420 presents various graphical representations of fund 108 including graphical representation 422, graphical representation 424 and graphical representation 426. GUI 420 may also provide a table 428 representing details of transaction history of fund 108).

Graphical representation 422 may present to the operator a visual representation of allocations of fund 108 between STRIPS bonds and investment vehicles of the Plus portion together with dollar figure of the total amount invested in each investment vehicle.

Graphical representation 424 may present to the operator a visual representation of historical assured floor level (variable p described above) together with a percentage of fund 108 invested in each of the different investment vehicles.

Graphical representation 426 may present to the operator a visual representation of historical splits as of the time of current access to management platform 102 by the operator. For example, when the value fraction of investment vehicle 112 exceeds 20% of fund 108's value in the current period, management platform 102 rebalances fund 108 and reduce value fraction of investment vehicle 112 to 20%. At these rebalancing periods, a split reduces the number of STRIPS per TRIP share back to 1 (where 1 STRIP share pays $1 per year for 20 years). A numerical example of share splitting (1 share-1 dollar constraint) has been provided above.

Table 428 provides various information regarding transaction history, changes/returns of each investment vehicle, etc., as of the time of current access to management platform 102 by the operator. Option 429 provides the operator with an option to export the data of table 428 (e.g., as a PDF document sent to a designated email address).

GUI 420 also presents the operator with option 430 to exit management platform 102 or to update and rebalance fund 108.

FIG. 4D illustrates GUI 450, which may be displayed to the operator upon selection option 430. As shown in FIG. 4D, operator can enter various information based on which management platform 102 can perform the process of FIG. 3 to adjust/update allocation of assets of fund 108 between the different investment vehicles.

For example, GUI 450 can include various fields 452 and 454 for the operator to enter returns of the Plus portion of fund 108 and the return of STRIPs bond since the last time fund 108 was rebalanced (may be in millions of dollars).

GUI 450 can also include a field 456 for the operator to enter net amount of deposits and withdrawals since the last rebalance. By providing this information, and selecting option 458 to have management platform 102 carry out the process of FIG. 3, a message may be displayed for the operator for the operator to confirm the information provided via GUI 450 and to provide the recommended adjustments to fund 108. GUI 450 also provides a summary of allocation of assets of fund 108 between the different investment vehicles should the operator approve making the recommended adjustments. Option 459, once selected and activated, can either take the operator back to GUI 420 or exit management platform 102.

FIG. 4E illustrates GUI 460, which may be displayed to the operator upon selection option 458 on GUI 450 of FIG. 4D. GUI 460 may provide a summary of updates to fund 108 based on information provided on GUI 450 including information on updated parameters provided through GUI 450, recommended actions and portions of fund 108 in each investment vehicle after implementation of the updates. GUI 460 may also provide various options 462 and 464 for operator to have management platform 102 transmit recommendations to contacts via email, to pass the recommendations to a corresponding IT team, etc.

GUI 460 may also provide the operator to either go back to GUI 450 using option 466 or to confirm updates to allocation of assets of fund 108 using option 468.

Selecting option 466 may trigger a confirmation message that may ask the operator to confirm the adjustment and updates. Upon confirming, the operator is redirected to GUI 410 with updated allocations after implementing the recommended adjustments using method of FIG. 3.

Having described example embodiments of the asset management tool and the platform on which it may be implemented with reference to FIGS. 1-3, the disclosure now turns to description of example components of a system architecture and device that enable implementation of the described asset allocation algorithms. In other words, FIG. 5 will be used to described example components of management platform 102, record keeper 104 and/or terminals 106.

FIG. 5 illustrates example components of an asset management tool of FIG. 1, according to one aspect of the present disclosure.

In this example, FIG. 5 illustrates a computing system 500 including components in electrical communication with each other using a connection 505, such as a bus. System 500 includes a processing unit (CPU or processor) 510 and a system connection 505 that couples various system components including the system memory 515, such as read only memory (ROM) 520 and random access memory (RAM) 525, to the processor 510. The system 500 can include a cache of high-speed memory connected directly with, in close proximity to, or integrated as part of the processor 510. The system 500 can copy data from the memory 515 and/or the storage device 530 to the cache 512 for quick access by the processor 510. In this way, the cache can provide a performance boost that avoids processor 510 delays while waiting for data. These and other modules can control or be configured to control the processor 510 to perform various actions. Other system memory 515 may be available for use as well. The memory 515 can include multiple different types of memory with different performance characteristics. The processor 510 can include any general purpose processor and a hardware or software service, such as service 1 532, service 2 534, and service 3 536 stored in storage device 530, configured to control the processor 510 as well as a special-purpose processor where software instructions are incorporated into the actual processor design. The processor 510 may be a completely self-contained computing system, containing multiple cores or processors, a bus, memory controller, cache, etc. A multi-core processor may be symmetric or asymmetric. The storage device 530 can be local and directly attached to connection 505 or can be located far away and communicatively coupled to other components of system 500.

To enable user interaction with system 500, an input device 545 can represent any number of input mechanisms, such as a microphone for speech, a touch-sensitive screen for gesture or graphical input, keyboard, mouse, motion input, speech and so forth. An output device 535 can also be one or more of a number of output mechanisms known to those of skill in the art. In some instances, multimodal systems can enable a user to provide multiple types of input to communicate with system 500. The communications interface 540 can generally govern and manage the user input and system output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof.

The storage device 530 can include services 532, 534, 536 for controlling the processor 510. Other hardware or software modules are contemplated. The storage device 530 can be connected to the system connection 505. In one aspect, a hardware module that performs a particular function can include the software component stored in a computer-readable medium in connection with the necessary hardware components, such as the processor 510, connection 505, output device 535, and so forth, to carry out the function.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” refers to at least one of a set and indicates that one member of the set or multiple members of the set satisfy the claim. For example, claim language reciting “at least one of A and B” means A, B, or A and B.

1. An asset management tool configured to periodically adjust allocation of assets within a fund between different investment vehicles such that a desired minimum outcome for each investor is assured on a corresponding target date, the asset management tool comprising:
one or more memories having computer-readable instructions stored therein; and
one or more processors configured to execute the computer-readable instructions to, at a given time,
determine an updated net asset value of a fund, the net asset value of the fund being a result of all contributions by a first number of investors to the fund less all withdrawals from the fund by a second number of investors;
determine a current value of each share of the fund based on a corresponding value of each of the different investment vehicles;
determine performance information associated with each of the different investment vehicles;
based on the current value of each share of the fund, the performance information associated with each of the different investment vehicles and a corresponding number of shares of the fund owned by each investor, automatically adjust the allocation of the net asset value of the fund between the different investment vehicles such that for each investor, a minimum outcome consistent with the corresponding number of shares owned by each investor is assured starting at a corresponding target date; and
communicate adjustments to the allocation of the net asset value to a trading desk for implementation.

2. The asset management tool of claim 1, wherein the different investment vehicles include a first investment vehicle and a second investment vehicle, the first investment vehicle being U.S. Treasury Separate Trading of Registered Interest and Principal of Securities (STRIPS), the second investment vehicle being an equity fund.

3. The asset management tool of claim 2, wherein the one or more processors are configured to execute the computer-readable instructions to adjust the allocation of the net asset value of the fund between the first investment vehicle and the second investment vehicle according to an investment rule governed by whether corresponding performance information of the second investment vehicle is equal to or greater than a threshold.

4. The asset management tool of claim 3, wherein when the corresponding performance information of the second investment vehicle is equal to or greater than the threshold, a portion of the net asset value of the fund is invested in the first investment vehicle at the given time, the portion of the net asset value corresponding to a weight of the portion of the fund invested in the first investment vehicle, at the given time, before any contributions are made to the fund at the given time.

5. The asset management tool of claim 3, wherein when the corresponding performance information of the second investment vehicle is less than the threshold, a portion of the net asset value of the fund is invested in the first investment vehicle at the given time according to:
$${F}_{t + 1} = p + \frac{{V}_{t + 1}^{-}}{{I}_{t + 1}} ( p - {f}_{t + 1}^{-} )$$
where t+1 is the given time, Fₜ₊₁ is the investment rule at time t+1, p is a floor of the fund below which value of the fund does not fall, Vₜ₊₁⁻ is a value of the fund at time t+1 before any contributions to the fund is made at time t+1, Iₜ₊₁ is an aggregate net investment in the fund at time t+1 and fₜ₊₁⁻ is a weight of the portion of the fund invested in the first investment vehicle at t+1 before any contributions are made to the fund at t+1.

6. The asset management tool of claim 1, wherein the corresponding target date for each investor starts 10 years from a date on which a corresponding investor initiates investment in the fund.

7. The asset management tool of claim 1, wherein the computer-readable instructions are executed by the one or more processors, every time there is a change in the net asset value of the fund.

8. The asset management tool of claim 1, wherein the asset management tool is configured to communicate with a record keeping component to keep track of identifying information and ownership portion of the fund for each investor and ownership portion of the fund.

9. The asset management tool of claim 1, wherein the minimum outcome is an assured minimum annual payment corresponding a number of shares of the fund owned by the corresponding investor at the corresponding target date.

10. The asset management tool of claim 1, wherein the minimum outcome is paid to the corresponding investor for a period of 20 years starting on the corresponding target date.

11. One or more non-transitory computer-readable medium having computer-readable instructions, which when executed by one or more processors, cause the one or more processors to provide an asset management tool to periodically adjust allocation of assets within a fund between different investment vehicles such that a desired minimum outcome for each investor is assured on a corresponding target date, the computer-readable instructions comprising instructions for:
determining an updated net asset value of a fund, the net asset value of the fund being a result of all contributions by a first number of investors to the fund less all withdrawals from the fund by a second number of investors;
determining a current value of each share of the fund based on a corresponding value of each of the different investment vehicles;
determining performance information associated with each of the different investment vehicles;
based on the current value of each share of the fund, the performance information associated with each of the different investment vehicles and a corresponding number of shares of the fund owned by each investor, automatically adjusting the allocation of the net asset value of the fund between the different investment vehicles such that for each investor, a minimum outcome consistent with the corresponding number of shares owned by each investor is assured starting at a corresponding target date; and
communicating adjustments to the allocation of the net asset value to a trading desk for implementation.

12. The one or more non-transitory computer-readable medium of claim 11, wherein the different investment vehicles include a first investment vehicle and a second investment vehicle, the first investment vehicle being U.S. Treasury Separate Trading of Registered Interest and Principal of Securities (STRIPS), the second investment vehicle being an equity fund.

13. The one or more non-transitory computer-readable medium of claim 12, wherein the execution of the computer-readable medium by the one or more processors cause the one or more processor to adjust the allocation of the net asset value of the fund between the first investment vehicle and the second investment vehicle according to an investment rule governed by whether corresponding performance information of in the second investment vehicle is equal to or greater than a threshold.

14. The one or more non-transitory computer-readable medium of claim 13, wherein when the corresponding performance information of the second investment vehicle is equal to or greater than the threshold, a portion of the net asset value of the fund is invested in the first investment vehicle at the given time, the portion of the net asset value corresponding to a weight of the portion of the fund invested in the first investment vehicle, at the given time, before any contributions are made to the fund at the given time.

15. The one or more non-transitory computer-readable medium of claim 13, wherein when the corresponding performance information of the second investment vehicle is less than the threshold, a portion of the net asset value of the fund is invested in the first investment vehicle at the given time according to:
$${F}_{t + 1} = p + \frac{{V}_{t + 1}^{-}}{{I}_{t + 1}} ( p - {f}_{t + 1}^{-} )$$
where t+1 is the given time, Fₜ₊₁ is the investment rule at time t+1, p is a floor of the fund below which value of the fund does not fall, Vₜ₊₁⁻ is a value of the fund at time t+1 before any contributions to the fund is made at time t+1, Iₜ₊₁ is an aggregate net investment in the fund at time t+1 and fₜ₊₁⁻ is a weight of the portion of the fund invested in the first investment vehicle at t+1 before any contributions are made to the fund at t+1.

16. The one or more non-transitory computer-readable medium of claim 11, wherein the corresponding target date for each investor starts 10 years from a date on which a corresponding investor initiates investment in the fund.

17. The one or more non-transitory computer-readable medium of claim 11, wherein the computer-readable instructions are executed by the one or more processors, every time there is a change in the net asset value of the fund.

18. The one or more non-transitory computer-readable medium of claim 11, wherein the asset management tool is configured to communicate with an external computing component functioning as a record keeping component to keep track of identifying information and ownership portion of the fund for each investor.

19. The one or more non-transitory computer-readable medium of claim 11, wherein the minimum outcome is an assured minimum annual payment corresponding a number of shares of the fund owned by the corresponding investor at the corresponding target date.

20. The one or more non-transitory computer-readable medium of claim 11, wherein the minimum outcome is paid to the corresponding investor for a period of 20 years starting on the corresponding target date.
